(19) United States
(12) Patent Application Publication
(10) Pub. No.: US 2008/0223452 A1
(43) Pub. Date: Sep. 18, 2008

(54) LEVEL DETECTION MODULE WITH LIQUID SUPPLY SYSTEM

(76) Inventor: JAO-CHING LIN, Taipei (TW)

Correspondence Address: G. LINK CO., LTD., 3550 BELL ROAD, MINOOKA, IL, 60447, US

(21) Appl. No.: 11/685,590

(22) Filed: Mar. 13, 2007

(51) Int. Cl. G01F 13/00

(52) U.S. Cl. 137/386; 73/292

(57) ABSTRACT

A level detection module is capable of detecting level of liquid in a container and includes the first induction unit, the second induction unit and a detection unit. The first and second induction units are disposed at the first position and second position of the container respectively and output the first and second induction signals respectively according to change of temperature. The detection unit provides a controller with input ends corresponding to the induction units and at least an output end. The controller compares the difference between the first and second induction signals and outputs a control signal, which stands for the liquid reaches to the preset position, based on difference of the signals via the output end. Due to temperature of the liquid at the bottom of the container being different from the room temperature of the air at the top of the container, the level of the liquid is measured with the principle of the difference of temperature.

### BACKGROUND OF THE INVENTION

1. Field of the Invention

The present invention is related to a level detection module with liquid supply system and particularly to a level detection module capable of measuring liquid level with difference between liquid temperature and room temperature, and to a liquid supply system capable of detecting liquid level.

2. Brief Description of the Related Art

Currently, apparatuses popularly employed for detecting liquid level in a container are buoy type level meter, pressure type level meter and sonar level meter. The buoy type level meter applies principle of buoying ball or buoying cylinder to measure liquid level and provides complicated mechanical device. The pressure type level meter and the sonar type level meter provide extremely sophisticate design with much expensive cost although more accurate level can be measured.

### SUMMARY OF THE INVENTION

The crux of the present invention resides in that when liquid enters a container, temperature of the liquid at the bottom of the container is different from room temperature at top of the liquid and the level in the container is detected based on the difference of temperature.

An object of the present invention is to provide a level detection module capable of measuring liquid level simply and a liquid supply system capable of detecting the liquid level.

Another object of the present invention is to provide a level detection module capable of measuring liquid level simply and a liquid supply system capable of detecting the liquid level in accordance with difference between water temperature and room temperature.

Accordingly, a level detection module according to the present invention is capable of detecting level of liquid in a container and includes the first induction unit, the second induction unit and a detection unit. The first and second induction units are disposed at the first position and second position of the container respectively and output the first and second induction signals respectively according to change of temperature. The detection unit provides a controller with input ends corresponding to the induction units and at least an output end. The controller compares the difference between the first and second induction signals and outputs a control signal, which stands for the liquid reaches to the preset position, based on difference of the signals via the output end.

Further, a liquid supply system capable of detecting the liquid level includes the preceding level detection module and a liquid suction device. The liquid suction device is driven by the controller for supplying the liquid to the container.

The level detection module and the liquid supply system capable of detecting liquid level provide the first and second induction units at different elevation of the container to produce the first and second induction signals with respect to change of temperature. In this way, position of the liquid level in the container can be learned easily.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a diagram of a preferred embodiment of a liquid supply system capable of detecting liquid level according to the present invention illustrating liquid has reached to the third level position;

FIG. 2 is a diagram similar to FIG. 1 illustrating that the liquid in the preferred embodiment has reached to the second level position, i.e., the two third of the liquid level;

FIG. 3 is a diagram similar to FIG. 2 illustrating that the liquid in the preferred embodiment has reached to the first level position, i.e., the one third of the liquid level; and

FIG. 4 is a diagram illustrating no liquid in the preferred embodiment.

### DETAILED DESCRIPTION OF THE INVENTION

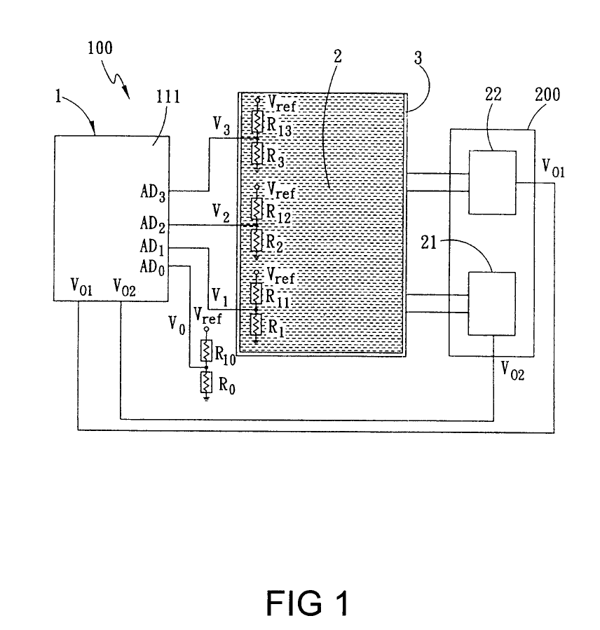

Referring to FIG. 1, a preferred embodiment of a liquid supply system capable of detecting liquid level according to the present invention is illustrated to detect level of liquid 2 in a container 3. The container 3 is a reservoir to make up liquid 2 needed by a portable cell such as the fuel cell. The liquid 2 is cold water with temperature lower than the room temperature.

The liquid supply system includes a level detection module 100 and a liquid suction device 200. The liquid suction device 200 in the instant embodiment has two water pumps 21, 21, which operate by means of receiving control signals V₀₁, V₀₂ of low level voltage output from the level detection module 100 so as to supply the liquid 2 to the container 3.

The container 3 is made of heat insulation material and the level detection module 100 is provided in the container 3. The container 3 can be made of heat conductive material instead and the level detection module 100 can be disposed outside the container 3 instead from stand point of a person familiar with the art. Hence, it is noted that the preceding change is belonged to the protected scope of the invention.

The level detection module 100 includes a detection unit 1, a room temperature induction unit R₀, a first induction unit R₁, a second induction unit R₂ and a third induction unit R₃. The induction units R₁, R₂ and R₃ are thermal resistance with positive temperature coefficient. It is noted that thermal resistance with negative temperature coefficient can be used instead from standpoint of the person familiar to the art while implementing concept of the invention.

The detection unit 1 includes a controller 111 and four divider resistances R₁₀, R₁₁, R₁₂, R₁₃. The controller 111 has four input ends (AD₀, AD₁, AD₂, AD₃) and two output ends (V_{O1}, V_{O2}). An end of the divider resistance R₁₀ connects with a voltage source V_{ref} and another end of the divider resistance R₁₀ connects with both the room temperature induction unit R₀ and the reference input end AD₀. The room temperature induction unit R₀ outputs a reference induction signal V₀ according to change of the room temperature.

The first induction unit R₁ is disposed at a first position in the container 3 and outputs a first induction signal V₁ according to change of the room temperature. An end of the divider resistance R₁₁ connects with the voltage source V_{ref} and another end of the divider resistance R₁₁ connects with both first induction unit R₁ and the first input end AD₁ to divide the voltage of the voltage source V_{ref} such that the first induction signal V₁ obtained by the first induction unit R₁ is sent to the first input end AD₁.

The second induction unit R₂ is disposed at a second position, which is located above the first position, and outputs a second induction signal V₂ according to change of the room temperature. An end of the divider resistance R₁₂ connects with the voltage source V_{ref} and another end of the divider resistance R₁₂ connects with both second induction unit R₂ and the second input end AD₂ to share the voltage of the voltage source V_{ref} such that the second induction signal V₂ obtained by the second induction unit R₂ is sent to the second input end AD₂.

Similarly, the third induction unit R₃ is disposed at a third position, which is located above the second position, and outputs a third induction signal V₃ according to change of the room temperature. An end of the divider resistance R₁₃ connects with the voltage source V_{ref} and another end of the divider resistance R₁₃ connects with both third induction unit R₃ and the third input end AD₂ to share the voltage of the voltage source V_{ref} such that the third induction signal V₃ obtained by the third induction unit R₃ is sent to the third input end AD₃.

When the liquid 2 reaches to the third position, i.e., the full level, the reference induction signal V₀ is unequal to the third induction signal V₃ and the first induction signal V₁ and the second induction signal V₂ are equal to the third induction signal V₃. Right at the moment, control signals V_{O1}, V_{O2} output from the controller 111 are high level voltage as shown in table 1 such that the two water pumps 21, 22 are not driven to supply water.

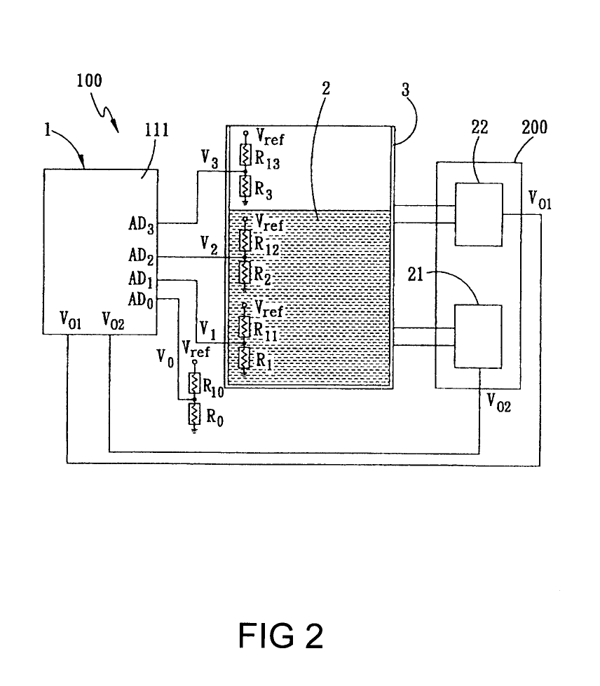

Referring to FIG. 2, once level of the liquid 2 is over the second position and under the third position, i.e., the two third of the full level, the reference induction signal V₀ is equal to the third induction signal V₃ and the first induction signal V₁ is equal to the second induction signal V₂ but both the induction signals V₁ and V₂ are unequal to the reference induction signal V₀. Right at the moment, the control signal V_{O1} is high level voltage and the control signal V_{O2} is low level voltage as shown in table 1 such that the water pump 21 is not driven and the water pump 22 is driven to supply water.

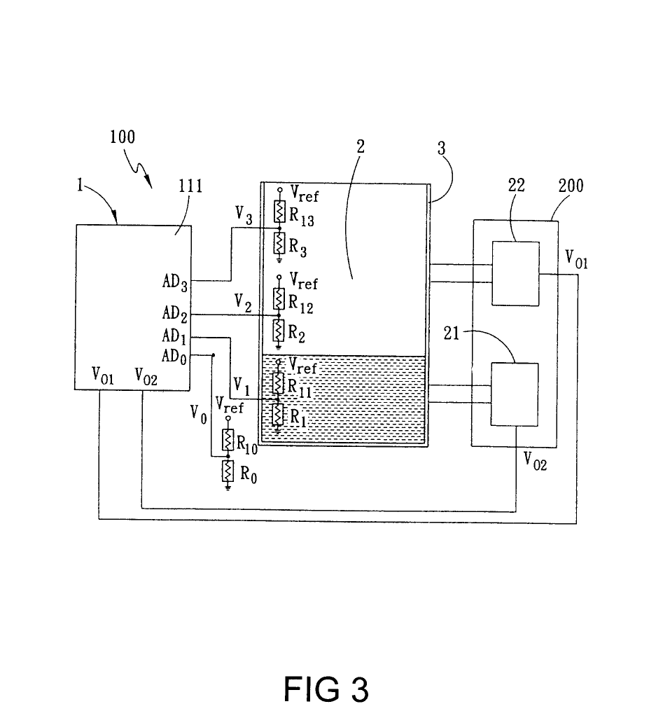

Referring to FIG. 3, once the liquid 2 is over the first position and under the second position, i.e., the one third level, the reference induction signal V₀, the second induction signal V₂ and the third induction signal V₃ are equal and the first induction signal V₁ is unequal to the reference induction signal V₀. Right at the moment, the control signal V_{O1} is low level voltage and the control signal V_{O2} is high level voltage as shown in table 1 such that the water pump 21 is driven to supply water and the water pump 22 is not driven.

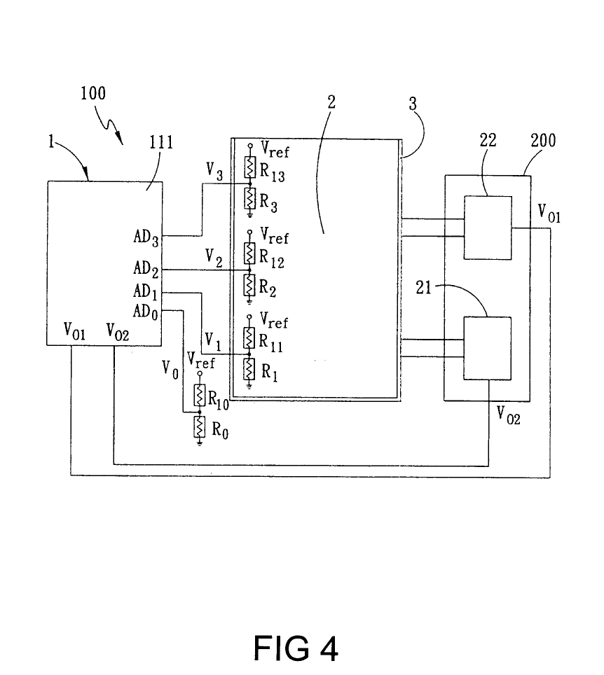

Referring to FIG. 4, when no liquid 2 is in the container 3, the first induction signal V₁, the second induction signal V₂ and the third induction signal V₃ are equal to each other. Right at the moment, the control signals V_{O1}, V_{O2} are low level voltages as shown in table 1 such that both the water pumps 21, 22 are driven to supply water.

TABLE 1

| | Relation | |
|---|---|---|
| Position of liquid level | between V₁, V₂ | Relation between Vₒ₁, Vₒ₂ |
| The third position | V₁ = V₂ = V₃ | Vₒ₁ = high level voltage (1) |
| (Full Level) | V₃ ≠ V₀ | Vₒ₂ = high level voltage (1) |
| The tecond position | V₀ = V₃ | Vₒ₁ = high level voltage (1) |
| (two third of the full | V₁ = V₂ ≠ V₀ | Vₒ₂ = low level voltage (0) |
| level) | | |
| The first position | V₀ = V₂ = V₃ | Vₒ₁ = low level voltage (0) |
| (one third if the full | V₁ ≠ V₀ | Vₒ₂ = high level voltage (1) |
| level) | | |
| No liquid | V₀ = V₁ = V₂ = V₃ | Vₒ₁ = low level voltage (0) |
| | | Vₒ₂ = low level voltage (0) |

Summarized the preceding description, when the liquid 2 enters the container 3, temperature of the liquid 2 at the bottom of the container 3 is different from the room temperature of the air at the top of the container 3 and the level detection module 100 provides the first, the second and the third induction units R₁, R₂ and R₃ at different elevations of the container 3 such that the first, the second and the third induction signals V₁, V₂ and V₃ produced by the first, the second and the third induction units R₁, R₂ and R₃ vary in accordance with the change of temperature. In this way, the level of the liquid 2 can be learned conveniently with the detection module instead of expensive instrument.

While the invention has been described with referencing to a preferred embodiment thereof, it is to be understood that modifications or variations may be easily made without departing from the spirit of this invention, which is defined by the appended claims.

What is claimed is:

1. A level detection module, which is capable of detecting level of liquid in a container with temperature of the liquid being different from room temperature, comprising:
a first induction unit, which is a room temperature induction unit, outputting a first induction signal according to change of temperature;
a second induction unit being disposed at a preset position of the container and outputting a second induction signal according to change of temperature; and
a detection unit providing a controller with a plurality of input ends corresponding to said induction units and at least an output end;
wherein the input ends couples the first induction unit and the second induction unit respectively to transmit the first induction signal and the second induction signal to the controller and the controller compares difference between the first induction signal and the second induction signal such that the controller is capable of outputting a control signal, which stands for the liquid reaching to the preset position, based on the difference.

2. The level detection module as defined in claim 1, wherein the controller is a analog/digital converter.

3. The level detection module as defined in claim 1, wherein the level detection unit further comprises a first divider resistance with an end thereof connecting with a voltage source and another end thereof connecting with both the first induction unit and one of the input ends of the controller such that the first induction unit shares a divider voltage from the voltage source and sends the first induction signal to a reference input end of the controller; and a second divider resistance with an end thereof connecting with the voltage source and another end thereof connecting with both the first induction unit and said input end of the controller such that the first induction unit shares divider voltage from the voltage source and sends the first induction signal to said input end.

4. The level detection module as defined in claim 1, wherein the first induction unit is a thermal resistance with positive temperature coefficient or negative temperature coefficient.

5. The level detection module as defined in claim 1, wherein the container is a reservoir of a portable cell.

6. A liquid supply system, which is capable of detecting liquid level for liquid in a container with temperature of the liquid being different from room temperature, comprising:
a level detection module, which further comprises:
a first induction unit, which is a room temperature induction unit, outputting a first induction signal according to change of temperature;
a second induction unit being disposed at a preset position of the container and outputting a second induction signal according to change of temperature; and
a detection unit providing a controller with a plurality of input ends corresponding to the induction units and at least an output end;
wherein the input ends couples the first induction unit and the second induction unit respectively to transmit the first induction signal and the second induction signal to the controller and the controller compares difference between the first induction signal and the second induction signal such that the controller is capable of outputting a control signal, which stands for the liquid reaching to the preset position, based on the difference; and
a liquid suction device being driven by the controller for supplying the liquid to the container.

7. The liquid supply system as defined in claim 6, wherein the controller is a analog/digital converter.

8. The liquid supply system as defined in claim 6 wherein the level detection unit further comprises a first divider resistance with an end thereof connecting with a voltage source and another end thereof connecting with both the first induction unit and one of the input ends of the controller such that the first induction unit shares a divider voltage from the voltage source and sends the first induction signal to a reference input end of the controller; and a second divider resistance with an end thereof connecting with the voltage source and another end thereof connecting with both the first induction unit and said input end of the controller such that the first induction unit shares divider voltage from the voltage source and sends the first induction signal to said input end.

9. The liquid supply system as defined in claim 6, wherein the first induction unit is a thermal resistance with positive temperature coefficient or negative temperature coefficient.
